(19) United States
(12) Patent Application Publication
(10) Pub. No.: US 2026/0055632 A1
(43) Pub. Date: Feb. 26, 2026

(54) Roof Tent, Roof System As Well As Method For Folding A Roof Tent In And Out

(71) Applicant: VDL Hapro B.V., Kapelle (NL)

(72) Inventors: Paul Van Der Leest, Kapelle (NL); Menno Mastenbroek, Kapelle (NL)

(21) Appl. No.: 19/105,393

(22) PCT Filed: Aug. 22, 2023
(86) PCT No.: PCT/NL2023/050429

§ 371 Date: Feb. 21, 2025

(30) Foreign Application Priority Data
Aug. 24, 2022 (NL) 2032841

(51) Int. Cl. E04H 15/06; B60P 3/38; B60R 3/02; E04H 15/32; E04H 15/46; E04H 15/56

(52) U.S. Cl. CPC E04H 15/06; B60P 3/38; B60R 3/02; E04H 15/322; E04H 15/46; E04H 15/56

(57) ABSTRACT

The invention relates to a roof tent comprising a bottom as well as a tent mechanism connected to the bottom, which folds up and out, comprising at least one canvas. The invention further relates to a roof system provided with a roof tent as described herein. The invention also relates to a method for folding a roof tent in and out as described herein.

The invention relates to a roof tent comprising a bottom as well as a tent mechanism, connected to the bottom, that folds up and out with at least one canvas.

The invention further relates to a roof system provided with a roof tent as disclosed herein.

The invention also relates to a method for folding a roof tent in and out as disclosed herein.

A roof tent is an accessory that can be installed on the roof of a motor vehicle, so that users of the roof tent can sleep relatively safely and comfortably above the vehicle and the interior space of the vehicle remains free, i.e. the roof tent does not require any luggage space in the vehicle. These roof tents normally comprise a bottom as well as a tent mechanism, connected to the bottom, which folds up and out and is provided with a canvas. A drawback of known roof tents is that the stretching of canvas can be relatively difficult, and/or that age and/or effects of the weather will in time alter the properties, such as expansion or shrinkage, of the canvas, which has an effect on the stretching of the canvas or keeping the canvas taut.

An object of the present invention is to provide an improved roof tent and/or a roof tent that can be put up relatively quickly and/or in a user-friendly manner with a canvas that can be stretched relatively easil4y.

At least one of these objects is achieved with the aid of the roof tent as defined in claim 1.

The roof tent comprises a bottom as well as a tent mechanism, connected to the bottom, that folds up and out with at least one canvas that can be stretched with the aid of a stretching unit. The stretching unit of the roof tent is provided with at least one tent pole that is connected to or is to be connected to the canvas, one end of which is provided with a connecting piece with which the tent pole is connected to or is to be connected to the bottom in a freely rotatable manner. In the state when connected to the canvas and the bottom, the tent pole can rotate in more than one plane. In this way the canvas can be stretched relatively easily with the aid of the freely rotatable connection between tent pole and bottom. That is, the stretching unit makes the stretching of the canvas by means of the tent pole possible in a user-friendly manner and/or makes relatively quick installation of the roof tent possible despite the relatively large height relative to the ground on which the vehicle stands, with the roof tent on top of it. Moreover, changing properties of the canvas for example as a result of weather effects or age can be compensated relatively simply by freely rotating the tent pole, so that the canvas can be stretched in the desired manner by means of the tent pole. The tent pole may be configured as a telescopic tent pole, so that the length of the tent pole can be changed by the sliding in or out of the telescopic tent pole in a user-friendly manner, wherein by means of the freely rotatable connection between tent pole and bottom, the tent pole is oriented automatically relative to the bottom without having to carry out further operations. The part of the tent pole that slides in and out may be located closer to the end of the tent pole to be connected to the canvas than the opposite end of the tent pole to be connected to the bottom. The connecting piece may be connected manually to the bottom in a detachable manner, without the need for tools or the like. It is also possible that the connecting piece is connected to the bottom in a nondetachable manner. The connecting piece of the tent pole may be provided with a head-shaped element that is connected to or is to be connected to a fastening element of the bottom. For example, a head-shaped element that is configured as a component of a ball joint in which the head-shaped element is spherical, as a component of a condyloid joint that comprises a cup and an elliptical joint surface or as a component of a saddle joint in which the head-shaped element is saddle-shaped. The bottom therefore comprises a fastening element that is configured correspondingly, i.e. bowl-shaped for the ball joint or the condyloid joint and saddle-shaped for the saddle joint. The fastening element may be applied on or near a peripheral edge of the bottom. The head-shaped element may at least partially need to be pressed in to provide a connection with the fastening element, for example the head-shaped element is made of a more elastic material than the fastening element of the bottom. The head-shaped element may be fastened manually by means of minimal temporary deformation in the fastening element and removed therefrom in a relatively quick, user-friendly manner.

In a further aspect, the stretching unit is provided with at least one further tent pole that is configured to be identical to the tent pole described above, wherein the two tent poles, at a distance from one other, are to be connected or are connected, freely rotatably, to the bottom. With the aid of a stretching unit of this kind, a canvas can be stretched relatively easily, for example for forming a tent (pavilion) roof and/or tent awning of the roof tent. Keeping a tent roof and/or tent awning of the roof tent under the proper tension is particularly important for correct draining of precipitation to prevent sagging of the canvas as a result of precipitation, with the risk of leakage.

The stretching unit may further be provided with two supporting tent poles, which each comprise a first end that is connected to or is to be connected to one of the two tent poles near an end thereof by which the canvas is to be connected or is connected to the tent pole. The roof tent may thereby, in an unfolded usage state thereof, define an acute angle to be set between each supporting tent pole and tent pole that is within an angular range of 50-85 degrees. By means of a stretching unit of this kind it is possible to stretch a tent roof and/or tent awning of the roof tent in a user-friendly manner. The roof tent may be provided with an access opening that is kept free from the stretching unit in an unfolded usage state of the roof tent. In this way a user can gain access via the access opening to the interior space of the roof tent, without being hampered by the stretching unit.

In another aspect, the tent pole of the roof tent, in an unfolded usage state, makes an adjustable obtuse angle with the bottom that is greater than 90 degrees and is less than or equal to 150 degrees, and is preferably less than or equal to 135 degrees. By means of these tent poles of the stretching unit it is possible to stretch a tent roof and/or tent awning of the roof tent in such a way that the tent roof and/or tent awning can project relative to the bottom of the roof tent, which can provide shade, as well as forming additional protection against precipitation.

The invention further relates to a roof system that is provided with a roof tent as disclosed herein. The roof system may be provided with a roof system opening mechanism, for example a gas spring, by means of which the roof system can be folded open automatically and the parts of the tent mechanism connected to the roof system can be folded out at least partially.

The invention also relates to a method for folding a roof tent in and out as disclosed herein between a transport state and a usage state of the roof tent. By means of the method, a roof tent as described above can be set up relatively easily by a user. The tent mechanism of the roof tent may for example be unfolded partly automatically by means of the opening mechanism of the roof system, wherein the canvas can be stretched manually in a user-friendly manner by means of the stretching unit, for obtaining a usage state of the roof tent.

The aspects described in this document will be explained hereunder on the basis of an embodiment example in combination with the figures. The invention is not, however, limited to the embodiment example described hereunder. Rather, a number of variants and modifications are possible, which also make use of the idea of the invention and consequently fall within the scope of protection. In particular, the possibility is mentioned of combining the features/aspects that are only mentioned in the description and/or are shown in the figures, with the features in the claims or features shown in other figures, in so far as compatible.

Reference is made to the following figures, in which:

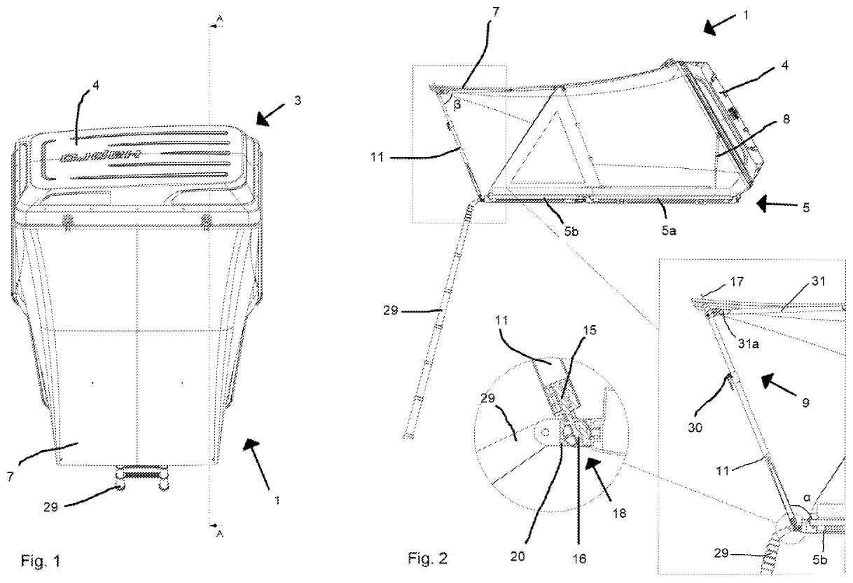

FIG. 1 shows a top view of a roof tent;

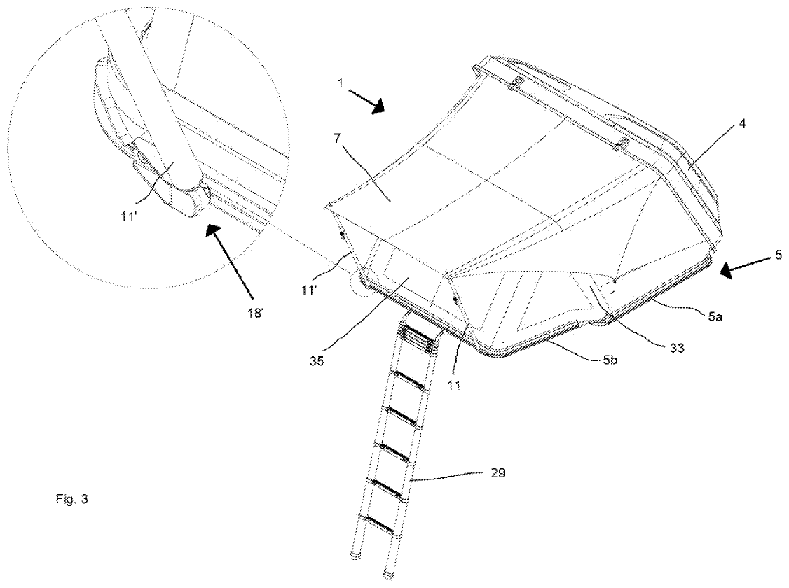

FIG. 2 shows a longitudinal section along line A-A of the roof tent shown in FIG. 1, wherein certain parts of the roof tent are additionally shown enlarged;

FIG. 3 shows a perspective view of the roof tent as well as an enlarged part of the roof tent.

In the figures, the same components are given the same reference symbols.

The roof system 3 shown in the figures comprises a roof tent 1 as well as an upper cover part 4 that folds in and out, and a bottom part 5. The roof tent can be unfolded or folded out from a transport state (not shown), in which only the relatively compact folded-in roof system 3 is visible, to a usage state of the roof tent 1 as shown in the figures, and vice versa. In the transport state, the motor vehicle (not shown), on which the roof system 3 with the roof tent 1 stowed therein is fastened, can be driven along the public highway. The roof system 3 is provided with at least one gas spring 8, with which the roof system 3 can be folded open automatically and the parts of the tent mechanism connected to the roof system 3 can be folded out at least partially.

The bottom part 5 of the roof system 3 also forms the bottom 5 of the roof tent in the usage state of the roof tent 1. The bottom 5 is provided with a first bottom section 5a and a second bottom section 5b, wherein the bottom sections 5a, 5b are joined together movably, in particular hinged, in order to move between a transport position (not shown) and a roof tent position in which the bottom sections 5a, 5b form an enlarged bottom floor of the roof tent 1.

The roof tent 1 shown, in the usage state thereof that is shown, is built up from the upper cover part 4 of the roof system 3, the bottom 5 as well as a tent mechanism, connected to the bottom, that folds up and out, comprising canvases for forming the roof tent 1. The roof tent 1 comprises at least one (tent) canvas, in the figures the awning cloth or roof cloth indicated with reference number 7, which can be stretched with the aid of a stretching unit 9.

The stretching unit 9 of the roof tent 1 is provided with at least one tent pole 11 that is connected to or is to be connected to the canvas 7, one end of which is provided with a connecting piece 15 with which the tent pole 11 is connected or is to be connected freely rotatably to the bottom 5. The opposite end of the tent pole 11 is provided with a fastening means 17 with which the tent pole is to be connected to the canvas 7. In the embodiment example shown, this end of the tent pole 11 comprises a pin 17, which can be pushed manually through an opening near the peripheral edge of the canvas 7 to create a detachable connection between canvas 7 and tent pole 11. It is possible to use other fastening means, not shown, for creating a connection between canvas 7 and tent pole 11.

The connecting piece 15 is provided with a head-shaped element 16 (FIG. 2), in particular a spherical component of a ball joint 18 that is connected to or is to be connected to a fastening element 20 of the bottom 5, in particular a bowl-shaped fastening element 20 of the ball joint 18 in which the spherical head-shaped element 16 is to be fitted. In the connected state of the ball joint 18 shown, the tent pole 11 that is also connected to the canvas 7 can rotate in more than one plane, in other words in at least two planes. It is to be noted that instead of the ball joint 18, other constructions of joints mentioned above are also possible for providing said rotation of the tent pole 11 in more than one plane.

The head-shaped element 16 may need to be pressed in at least partially to provide a connection with the fastening element 20, for example the head-shaped element 16 is made of a more elastic material than the fastening element 20 of the bottom 5. As shown, the fastening element 20 is applied at or near a peripheral edge 25 of the bottom 5, more particularly at the peripheral edge 25 of the second bottom section 5b. It is also possible that the tent pole 11 is connected permanently (not detachable manually) by means of the ball joint 18 to the fastening element 20 of the bottom, wherein after the canvas 7 has been fastened to the tent pole 11, the canvas 7 is to be stretched.

The bottom 5 is connected to or is to be connected to a centrally mounted telescopic ladder 29, with which the bottom 5 is to be supported and the roof tent is accessible for a user. The ladder 29 is hinged to the peripheral edge 25 of the second bottom section 5b. The ladder 29 is connected permanently to the bottom, but it is possible to connect the ladder detachably to the bottom 5. The ladder 29 is configured to slide in and out telescopically, wherein in the extended state of the ladder 29, the ladder comprises both a ladder function and a supporting function of the bottom 5.

In an unfolded usage state of the roof tent 1, the tent pole 11 of the roof tent 1 makes an adjustable obtuse angle α (FIG. 2) with the bottom 5 that is greater than 90 degrees and is less than or equal to 150 degrees, and is preferably less than or equal to 135 degrees. The adjustable obtuse angle α forms a first rotational degree of freedom of the ball joint 18 of the stretching unit 9 for stretching the canvas 7 by means of the tent pole. A second rotational degree of freedom of the ball joint 18 is for example rotation in the plane of the drawing in FIG. 2.

The tent pole 11 is configured as a telescopic tent pole 11 so that the length of the tent pole can be changed relatively easily and the canvas 7 can be stretched in a quick and user-friendly manner by means of the freely rotatable connection 18 that allows rotation in more than one plane of the tent pole 11 connected to the canvas. The mechanism for operating (releasing and fastening) the telescopic parts of the tent pole is indicated in FIG. 2 with the reference number 30.

The stretching unit 9 shown is provided with at least one further tent pole 11′ that is configured to be identical to the tent pole 11, wherein the two tent poles 11, 11′ are to be connected or are connected, at a distance from one other, in an identical manner to the bottom 5 by means of the ball joints 18, 18′.

The stretching unit 9 is further provided with two supporting tent poles 31, only one of which is shown in FIG. 2. Each supporting tent pole 31 comprises a first end 31 that is connected to or is to be connected to one of the two tent poles 11, 11′ near an end thereof with which the canvas 7 is connected to or is to be connected to the tent pole 11, 11′. The roof tent 1 defines, in an unfolded usage state thereof, an acute angle β to be set between each supporting tent pole 31 and tent pole 11, 11′, which for stretching the canvas 7 is within an angular range of 50-85 degrees.

Besides canvas 7, the roof tent is provided with a canvas or canvases 33 that form a closable interior space of the roof tent 1, which is provided with an access opening 35, which is kept free from the stretching unit 9 in an unfolded usage state of the roof tent 1.

1. A roof tent comprising a bottom and a tent mechanism, connected to the bottom, that folds up and out with at least one canvas that can be stretched with the aid of a stretching unit, wherein the stretching unit of the roof tent is provided with at least a first tent pole that is connected to or is to be connected to the canvas, one end of which is provided with a connecting piece with which the first tent pole is connected to or is to be connected to the bottom in a freely rotatable manner.

2. The roof tent as claimed in claim 1, wherein the first tent pole is a telescopic tent pole.

3. The roof tent as claimed in claim 1, wherein the connecting piece is to be connected manually to the bottom in a detachable manner or is connected to the bottom in a manner that is nondetachable manually.

4. The roof tent as claimed in claim 1, wherein the connecting piece is provided with a head-shaped element which is connected to or is to be connected to a fastening element of the bottom.

5. The roof tent as claimed in claim 4, wherein the head-shaped element is to be pressed in at least partially to provide a connection with the fastening element.

6. The roof tent as claimed in claim 1, wherein at least one of a tent roof or a tent awning of the roof tent is to be provided by means of the canvas.

7. The roof tent as claimed in claim 1, wherein the bottom is provided with a first bottom section and a second bottom section, wherein the first and second bottom sections are joined together movably in order to move between a transport position and a roof tent position in which the first and second bottom sections form a bottom of the roof tent.

8. The roof tent as claimed in claim 4, wherein the fastening element is applied at or near a peripheral edge of the bottom.

9. The roof tent as claimed in claim 1, wherein the stretching unit is provided with at least a second tent pole that is configured to be identical to the first tent pole, wherein the first and second tent poles, at a distance from one other, are to be connected or are connected, freely rotatably, to the bottom.

10. The roof tent as claimed in claim 9, wherein the stretching unit is provided with two supporting tent poles which each comprise a first end that is connected to or is to be connected to one of the first and second tent poles near an end thereof by which the canvas is to be connected or is connected to the first and second tent pole.

11. The roof tent as claimed in claim 10, wherein the roof tent, in an unfolded usage state thereof, defines an acute angle to be set between each supporting tent pole and one of the first or second tent poles, wherein the acute angle is within an angular range of 50-85 degrees.

12. The roof tent as claimed in claim 1, wherein the at least one of the first or second tent poles of the roof tent, in an unfolded usage state, makes an adjustable obtuse angle with the bottom that is greater than 90 degrees and is less than or equal to 150 degrees.

13. The roof tent as claimed in claim 1, wherein the bottom is to be connected or is connected to a centrally mounted telescopic ladder, with which the bottom is to be supported and the roof tent is accessible for a user.

14. The roof tent as claimed in claim 1, wherein the roof tent is provided with an access opening that is kept free from the stretching unit in an unfolded usage state of the roof tent.

15. A roof system comprising a roof tent as claimed in claim 1.

16. The roof system as claimed in claim 15, further comprising a roof system opening mechanism by which the roof system can be folded open automatically and the parts of the tent mechanism connected to the roof system can be folded out at least partially.

17. A method for folding the roof tent as claimed in claim 1, the method comprising folding the roof tent in and out between a transport state and a usage state of the roof tent.
